(19) United States
(12) Patent Application Publication
(10) Pub. No.: US 2006/0291095 A1
(43) Pub. Date: Dec. 28, 2006

(54) Magnetic disk apparatus

(75) Inventors: Hitoshi Inoue, Higashine (JP); Kazunori Shikano, Higashine (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMTED, Kawasaki (JP)

(21) Appl. No.: 11/213,977

(22) Filed: Aug. 30, 2005

(30) Foreign Application Priority Data
Jun. 28, 2005 (JP) 2005-187781

(51) Int. Cl. G11B 33/14

(52) U.S. Cl. 360/97.02

(57) ABSTRACT

A magnetic disk apparatus includes a base body of which one surface is opened, a cover part covering the opened surface of the base body, and a recording and reproducing part provided on the base body and having a magnetic disk and a magnetic head received in a space formed between the base body and the cover part. A convex part is provided along a perimeter of a circumference edge part of one of the base body and the cover part. A first surface of the convex part faces a second flat surface. A packing for sealing is fixed to the first surface of the convex part so as to come in contact with the second flat surface.

### BACKGROUND OF THE INVENTION

1. Field of the Invention

The present invention generally relates to magnetic disk apparatuses, and more specifically a magnetic disk apparatus having a structure having good sealability (the structure is sealable).

2. Description of the Related Art

These days, a magnetic disk apparatus is used not only as an auxiliary storage apparatus of a computer but also for a portable terminal apparatus or a video apparatus. As demand for using the magnetic disk apparatus is expanded, high capacity and miniaturization of the magnetic disk apparatus are required.

FIG. 1 is an exploded perspective view of a related art magnetic disk apparatus. As shown in FIG. 1, the magnetic disk apparatus 100 includes a housing 101. A magnetic disk 102, a magnetic head 103, and an actuator 104 are provided on an upper surface of the housing 101. An electronic substrate (not shown in FIG. 1) for controlling the magnetic disk apparatus is provided on a lower surface of the housing 101. The magnetic disk apparatus 100 includes a cover body 105 for covering an upper surface of the housing 101 so that the inside of the magnetic disk apparatus 100 where the magnetic disk 102 and others are received is separated and sealed from the outside of the magnetic disk apparatus 100.

The magnetic head 103 performs a recording and reproduction operation and a seek operation in a diameter direction, while the magnetic head 103 flies above a surface of the magnetic disk 102 at a minute height. Since the magnetic head 103 flies at the minute height, a medium facing surface, namely a surface of the magnetic head 103 facing the magnetic disk 102, or a surface of the magnetic disk 102 are sustained in a clean state.

A frame 106 having a convex configuration and a small thickness is provided in a circumference edge part of the housing 101. The frame 106 comes in contact with an internal surface of the cover part 105. FIG. 2 is a plan view of the inside of the cover part 105. As shown in FIG. 2, a ring-shaped packing 108 is provided at the circumference edge part in an inside surface of the cover part 105.

FIG. 3 is a cross-sectional view taken along a line X1-X1 of FIG. 1. As shown in FIG. 3, the packing 108 is fixed to an inside surface of the cover part 105 by an adhesive member 108a. The cover part 105 is fixed with screw (screw-fixed) so that the packing 108 comes in contact with a contact surface 106a of the frame 106 of the housing 101. Under this structure, dust or low-molecular organic gas is prevented from penetrating into the inside of the magnetic recording apparatus from the outside. See Japan Laid-Open Patent Application Publication No. 2001-329248.

However, as shown in FIG. 3, there is a gap between a screw hole 105a of the cover body 105 and a screw 109. Hence, the cover body 105 has a clearance in a horizontal direction corresponding to this gap against the housing 101. Because of this, when the cover part 105 is screw-fixed to the frame 106 of the housing 101, the cover part 105 may be shifted by a distance equal to the length of the gap. FIG. 4 is a cross-sectional view taken along a line X2-X2 of FIG. 1. In this case, as shown in FIG. 4, a surface of the packing 108 is shifted from the contact surface 106a so that an area of a contact part is reduced. In addition, a gap between the surface of the packing 108 and the contact surface 106a of the frame may be formed. Thus, if the contact area is reduced too much or the gap is formed, dust or low-molecular organic gas contained in outside air may come into the inside of the apparatus from the outside. The dust or low-molecular organic gas may adhere to or contaminate a lubricating layer of a surface of the magnetic disk 102 shown in FIG. 1 so that a function of the lubricating layer is degraded. The dust or low-molecular organic gas may also adhere on the medium facing surface of the magnetic head 103 so that the flying stability of the magnetic head is degraded. In addition, in a case where a particle diameter of the dust is substantially the same as the flying height, if the dust goes in between the magnetic head and the magnetic disk, a scratch is formed on a protection film so that a head crash is generated. As a result of this, an error that may not be recovered from is generated in the magnetic disk apparatus so that reliability of the apparatus is degraded.

At the time of the operation of the magnetic disk apparatus, the pressure inside of the magnetic disk apparatus may be negative due to high speed rotation of the magnetic disk. In this case, since the outside air may easily go into the apparatus, a problem of dust coming in may be easily generated.

### SUMMARY OF THE INVENTION

Accordingly, it is a general object of the present invention to provide a novel and useful magnetic disk apparatus in which one or more of the problems described above are eliminated.

Another and more specific object of the present invention is to provide a magnetic disk apparatus whereby the inside of the magnetic disk apparatus is securely sealed so that high reliability can be obtained.

The above objects of the present invention are achieved by a magnetic disk apparatus, including:

a base body of which one surface is opened;

a cover part covering the opened surface of the base body; and

a recording and reproducing part provided on the base body and having a magnetic disk and a magnetic head received in a space formed between the base body and the cover part;

wherein a convex part is provided along a perimeter of a circumference edge part of one of the base body and the cover part;

a first surface of the convex part faces a second flat surface; and

a packing for sealing is fixed to the first surface of the convex part so as to come in contact with the second flat surface.

According to the present invention, the convex part is provided along the perimeter of the circumference edge part of either the base body or the cover part. The first surface of the convex part faces the second flat surface. The packing for sealing is fixed to the first surface of the convex part so as to come in contact with the second flat surface of the convex part. Therefore, even if the base body and the cover part are shifted in a horizontal direction, since the packing comes in contact with the flat second surface, the problem discussed with reference to FIG. 4 is not generated. Therefore, a good contact state between the packing and the second flat surface can be sustained. As a result of this, the inside of the magnetic disk apparatus where the recording and reproducing part is received is securely sealed. Hence, it is possible to provide a magnetic recording apparatus having high reliability.

Other objects, features, and advantages of the present invention will become more apparent from the following detailed description when read in conjunction with the accompanying drawings.

### BRIEF DESCRIPTION OF THE DRAWINGS

FIG. 1 is an exploded perspective view of the related art magnetic disk apparatus;

FIG. 2 is a plan view of the inside of a cover part of the related art;

FIG. 3 is a cross-sectional view taken along a line X1-X1 of FIG. 1;

FIG. 4 is a cross-sectional view taken along a line X2-X2 of FIG. 1;

FIG. 5 is an exploded perspective view of a magnetic disk apparatus of a first embodiment of the present invention;

FIG. 6 is a cross-sectional view taken along a line A-A of FIG. 5;

FIG. 7 is an enlarged view of a part B of FIG. 6;

FIG. 8A is a cross-sectional view of another example of a packing;

FIG. 8B is a view showing a state where the packing shown in FIG. 8A comes in contact with a cover part;

FIG. 9 is a cross-sectional view of another example of the packing;

FIG. 10 is an exploded perspective view of a magnetic disk apparatus of a second embodiment of the present invention;

FIG. 11 is a cross-sectional view taken along a line C-C of FIG. 10; and

FIG. 12 is an enlarged view of a part D of FIG. 11.

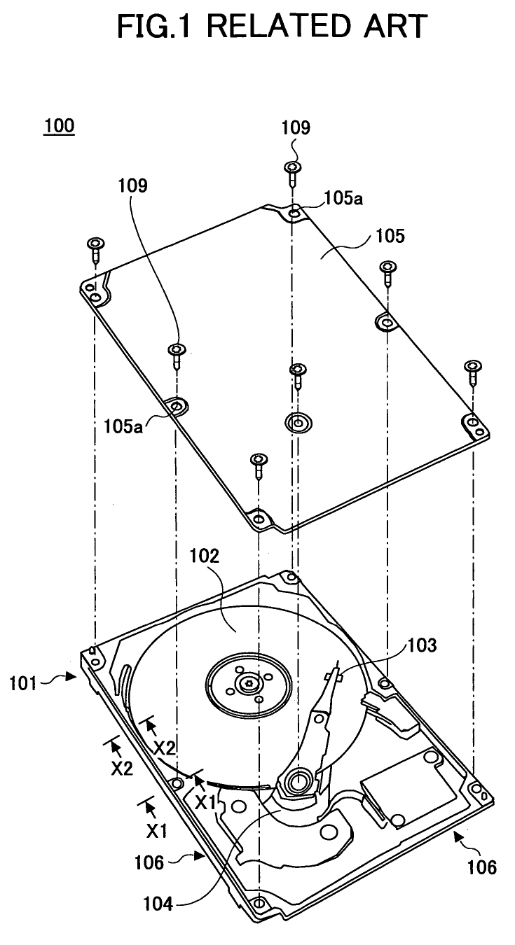

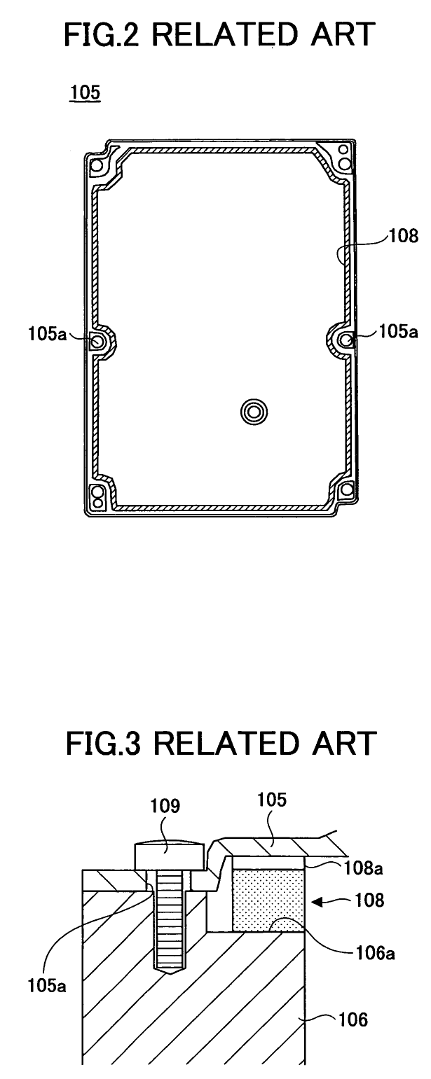

### DETAILED DESCRIPTION OF THE PREFERED EMBODIMENTS

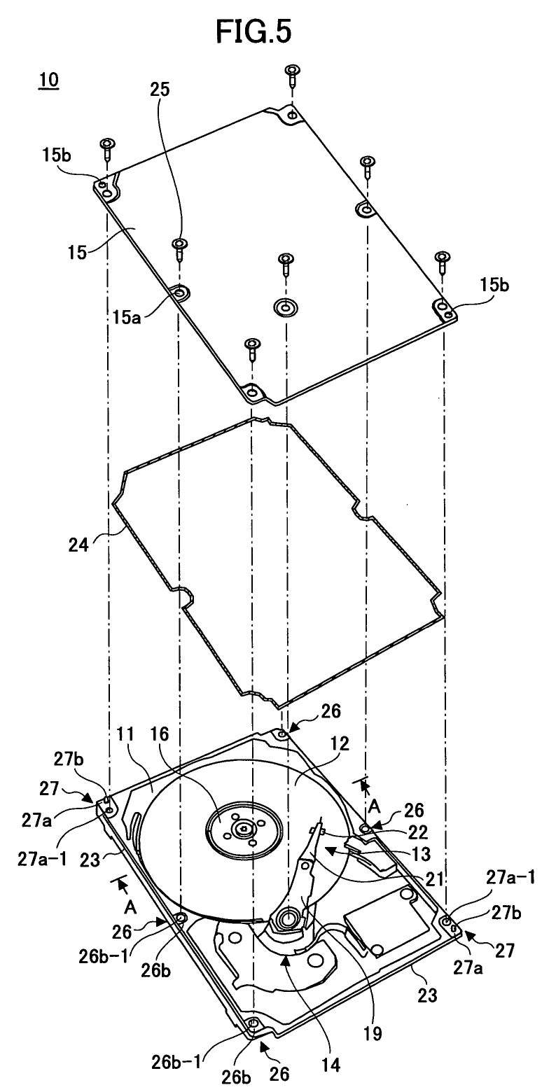

A description will now be given, with reference to FIG. 5 through FIG. 12, of embodiments of the present invention.

### First Embodiment

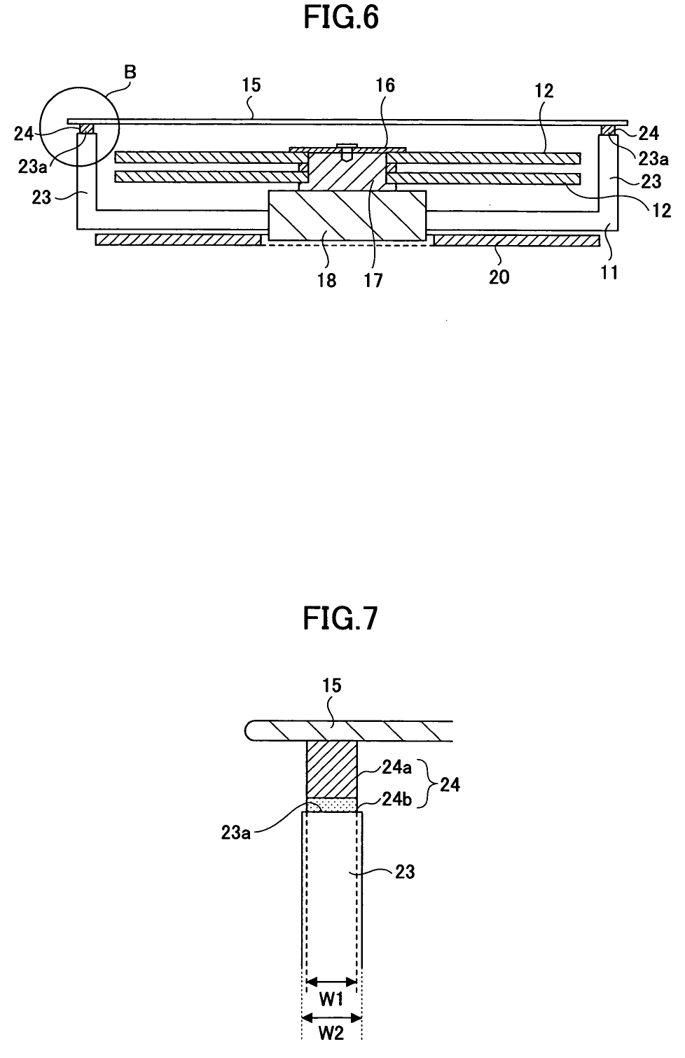

FIG. 5 is an exploded perspective view of a magnetic disk apparatus of a first embodiment of the present invention. FIG. 6 is a cross-sectional view taken along a line A-A of FIG. 5. The line A-A passes through a substantially center part of a spindle motor and is along a diameter direction of a magnetic disk.

Referring to FIG. 5 and FIG. 6, a magnetic disk apparatus 10 of the first embodiment includes a housing 11, a recording and reproducing part, a cover part 15, and others. The recording and reproducing part includes a magnetic disk 12 provided on the housing 11, a magnetic head 13, an actuator unit 14, and others. An opening part of the magnetic disk 12 is fitted around a rotational shaft 17. The magnetic disk 12 is fixed to a hub 16 from an upper side. The magnetic disk 12 is rotated by a spindle motor 18.

A base part of the magnetic head 13 is attached to an arm 19. The magnetic head 13 is provided to the actuator unit 14 via the arm 19. The magnetic head 13 is rotated in a diameter direction of the magnetic disk 12 by the actuator unit 14. In addition, an electronic substrate 20 is provided at a rear side of the housing 11 so as to control the magnetic disk apparatus 10 such as recording and reproducing control, magnetic head position control, and spindle motor control.

A recording layer, a protection layer covering the recording layer, and a lubricating layer are formed in the magnetic disk 12. Information is recorded in the recording layer. The recording layer may be formed by, for example, an in-plane magnetization film wherein parallel magnetization is formed in a film surface and a vertical magnetization film having magnetization in a direction perpendicular to the film surface.

The magnetic head 13 includes a suspension 21, a head slider fixed to a head end part of the suspension 21, an element part formed in the head slider 22 and configured to record and reproduce, and others. The element part records a recording magnetic field by magnetizing the recording layer of the magnetic disk 12 and detects the magnetic field from the recording layer so as to reproduce. The head slider 22 flies at a height of 10 nm through 20 nm, for example, from a magnetic surface as a result of air flow generated by high speed rotation of the magnetic disk 12. The operation of the recording and reproducing is done by the element part in a state where the head slider 12 flies.

The housing 11 and the cover body 15 are made of, for example, a metal material such as an aluminum alloy or stainless, a plastic material, or the like. A convex circumference edge part 23 is upwardly provided along a perimeter of an external circumference of the housing 11. A space where the recording and reproducing part such as the magnetic disk 12 is received is formed in an inside part between the concave circumference edge part 23 and the cover part 15.

While the circumference edge part 23 ensures the mechanical strength of the housing 11, the width of a part of the circumference edge part 23 is narrower than other part for receiving the magnetic disk 12 having a designated size and for miniaturizing the housing 11. The width of the circumference edge part 23 is narrow in an area adjacent to the magnetic disk 12.

An adhesive surface 23a where the packing 24 is fixed is provided on a top surface of the circumference edge part 23. The packing 24 has a ring-shaped configuration. As shown in FIG. 6, the packing 24 is fixed to the adhesive surface 23a of the circumference edge part 23.

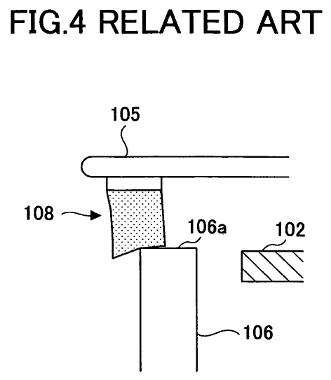

FIG. 7 is an enlarged view of a part B of FIG. 6. Referring to FIG. 7, the packing 24 has a plate-shaped configuration and is formed by the elastic member 24a and the adhesive member 24b. The packing 24 is fixed to the adhesive surface 23a of the circumference edge part 23 by the adhesive member 24b. A surface of the elastic member 24a comes in contact with an internal surface of the cover body 15. It is preferable that an area facing the adhesive surface 23a of the internal surface of the cover body 15 be made in a flat manner and the width of the area be longer than the width of the adhesive surface 23a. Under this structure, even if the housing 11 and the cover body 15 shown in FIG. 6 are shifted against each other in the horizontal direction, the problem discussed with reference to FIG. 4 may not be generated and therefore a good sealing state can be sustained. The cover body 15 may have a substantially plate-shaped configuration. Alternatively, only the internal surface of the circumference edge part of the cover body 15 may be plane.

The material of the adhesive member 24b is not limited as long as the packing 24 can be adhered. For example, an adhesive made of epoxy resin, or acrylic resin such as a double adhesive tape, can be used.

A elastic member 24a is made of a rubber material or elastomer. It is preferable to use nitrile rubber, nitrile hydroxide rubber, fluoride rubber, butyl rubber, acryl rubber, chloroprene rubber, chloro sulfonated polyethylene rubber, or epichlorohydrin rubber as the elastic member 24a because the above-mentioned materials have good resistance against permeability of gases. Even if the width of the packing 24 is narrowed, it is possible to prevent the gas from permeating through an elastic member and coming in from the outside. A polystyrene group thermoplastic elastomer or a polyolefin group thermoplastic elastomer may be used as the elastomer.

The packing 24 may be a molded packing formed by injection molding or the like. A cut packing formed by using a cutting die may be used as the packing 24. The elastic member 24b of the packing 24 may be flat and a center of the surface may be convex. Since the internal surface of the cover part 15 is flat, the packing 24 comes in good contact with the internal surface of the cover body 15 so that sealability of the inside of the housing 11 becomes good.

It is preferable that the width W1 of the packing 24 be narrower than the width W2 of the adhesive surface 23a from the perspective of that the packing 24 is prevented from being taken out from the adhesive surface 23a. Because of this, in the assembling process of the magnetic disk apparatus 10, when the magnetic disk 12 as shown in FIG. 6 is installed on the rotational shaft 17, the external periphery of the magnetic disk 12 may not come in contact with the packing 24. Adhesion of foreign material to the magnetic disk 12 and formation of scratches can be prevented by avoiding this contact.

In a case where a sufficient length between the external periphery part of the magnetic disk 12 and an inside of the circumference edge part 23 can be provided, the width W1 shown in FIG. 7 of the packing 24 may be wider than the width W2 of the adhesive surface 23a. Because of this, it is possible to improve the sealability and increase the resistance against the permeability of gases.

Referring to FIG. 7 together with FIG. 5, screw-fixing parts 26 for screw-fixing the cover body 15 are provided in the vicinity of the center and at four corners of the housing 11. The scre-fixing parts 26 and 27 have standard surfaces 26a and 27a, respectively, situated at a position slightly higher than the adhesive surface 23a. Screw holes 26a-1 and 27a-1 are respectively provided in the standard surfaces 26a and 27a. In a state where the cover body 15 is screw-fixed, the standard surfaces 26a and 27a and the internal surface of the cover body 15 directly come in contact with each other. Because of this, the cover body 15 presses the packing 24 so that the elastic member 24a is compressed and the internal surface of the cover body 15 and the surface of the elastic member 24a come in contact with each other. Thus, the inside of the housing 11 is sealed from the outside.

It is not necessary for the width of the packing 24 to be constant in any position in a longitudinal direction. The width of the packing 24 at a position corresponding to a position where a width of the circumference edge part 23 of the housing 11 is narrow may be narrow. The width of the packing 24 at a position corresponding to a position where a width of the circumference edge part 23 of the housing 11 is wide may be wide. Particularly, the width of the packing 24 at the circumference of the screw-fixing part 26 is made large. Because of this, pressure is applied to the packing 24 uniformly so that an amount of compression of the packing 24 is made uniform along the longitudinal direction. Thus, a contact state between the packing 24 and the internal surface of the cover body 15 is made better.

Opening parts 15b are provided in a diagonal line manner in the cover body 15 so as to position the cover body 15. When the cover body 15 is positioned at the housing 11, a convex part 27b is provided at the screw-fixing part 27 of the housing 11 and is inserted in the opening part 15b. A screw is inserted in the hole of the cover body 15 so that the cover body 15 and the housing 11 are screw-fixed. In this case, the cover body 15 may be shifted in a horizontal direction against the housing 11 at a distance equal to the length of a clearance between diameters of the screw and the hole. However, the packing 24 is fixed to the adhesive surface 23a of the housing 11, and the internal surface of the cover body 15 that is a surface contacting the packing is flat and has a wide width. Hence, a good contact state can be obtained and therefore good sealability can be obtained.

As shown in FIG. 7, the width of the circumference edge part 23 of the housing 11 adjacent to the external periphery part of the magnetic disk 12 is made narrow for miniaturization of the housing 11. Since the packing 24 is fixed to a side of the circumference edge part 23 even in this position, a contact state between the packing 24 and the internal surface of the cover body 15 is made good and therefore good sealability can be ensured.

In addition, in the assembling process of the magnetic disk apparatus 10, the recording and reproducing part such as the magnetic disk 12, the magnetic head 13, and the actuator unit 14 are assembled in the housing 11. Then, the packing 24 attached to the die in a adhering manner in advance is positioned against the housing 11. The packing 24 is provide and pressed on the adhesive surface 23a so that the adhesive member 24b of the packing 24 and the adhesive surface 23a are adhered to each other. Then, the cover body 15 is positioned against and provided on the housing 41 so as to be screw-fixed. Since the packing 24 is not exposed to the outside just before the cover body 15 is fixed in this process, a clean packing surface can be made to contact the internal surface of the cover body 15. Because of this, since it is possible to prevent dust from existing between the packing 24 and the internal surface of the cover body 15, a good sealing state can be formed. The packing 24 may have a cross-sectional configuration discussed below.

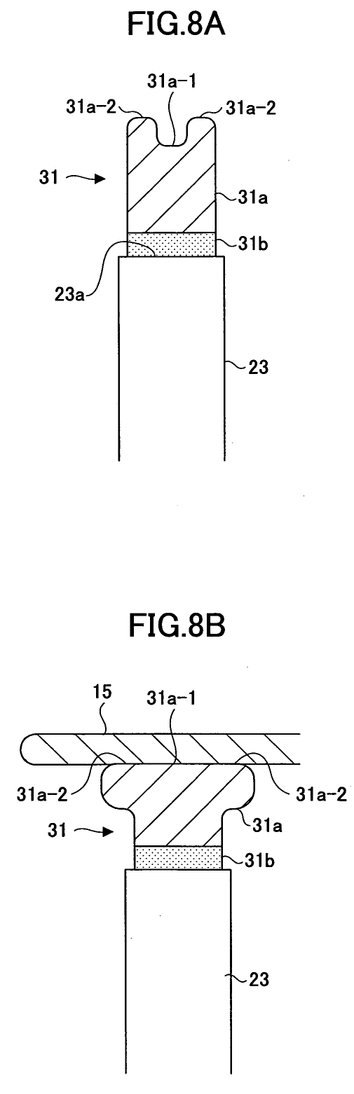

FIG. 8A is a cross-sectional view of another example of the packing. FIG. 8B is a view showing a state where the packing shown in FIG. 8A comes in contact with the cover part 15. Both FIG. 8A and FIG. 8B are cross-sectional views in the same direction as the direction of FIG. 6.

Referring to FIG. 8A, in a state where the cover body 15 does not come in contact with the packing 31, a groove forming part 31a-1 is provided in substantially the center of the width direction of the surface of the packing 31. Convex parts 31a-2 are provided at both sides of the grove forming part 31a-1. The groove forming part 31a-1 extends in the longitudinal direction of the packing 31.

As shown in FIG. 8B, in a state where the cover body 15 presses the packing 31, the convex part 31a-2 extends in the width direction so that the convex part 31a-2 and the groove forming part 31a-1 come in contact with the internal surface of the cover body 15. Because of this, since the contact area of the internal surface of the cover body 15 and the surfaces 31a-1 and 31a-2 of the packing increases, the sealing state becomes good. Such a packing 31 is effective in a position where the width of the packing 31 is limited. For example, it is possible to sustain the good sealing state by using the packing 31 in an area where the width of the circumference edge part 32 is small, such as an area adjacent to the external periphery part of the magnetic disk 12.

The packing 31 has the same structure as the packing shown in FIG. 7 except the configuration of the surface of the packing 31 is different from the packing shown in FIG. 7, and is made of the same material as the packing shown in FIG. 7.

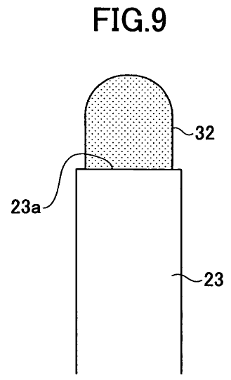

FIG. 9 is a cross-sectional view of another example of the packing. FIG. 9 is a cross-sectional view in the same direction as the direction of FIG. 6.

Referring to FIG. 9, the packing may be a liquid state packing 32. The liquid state packing 32 is made of a rubber state material formed by curing a liquid state curing type resin composition, for example. As such a liquid state curing type resin composition, silicon rubber or a mixture of base resin of copolymer including fluoride and a curing agent such as isocyanate can be used. The liquid state packing 32 is fixed to the adhesive surface 23a and achieves elasticity by being cured after being applied to the adhesive surface 23a in the liquid state.

The liquid state packing 32 is applied by a FIPG (Formed In Place Gasket) method using a robot mechanism. The housing 11 is fixed and a dispenser is controlled by a robot mechanism so that a designated amount of the liquid state packing is applied at positions programmed in advance. Since the width of the liquid packing 32 can be easily controlled by the FIPG method, the width of the liquid state packing 32 is adjusted to the width of the adhesive surface 23a so that it is possible to take the liquid state packing 32 out from the adhesive surface 23a.

In the case of the FIPG method, it is preferable that the liquid state packing 32 be applied before the magnetic disk and others are assembled in the housing. It is possible to prevent a liquid state thread from dropping down from the dispenser to the magnetic disk and others and prevent the magnetic disk from being not usable due to error.

According to this embodiment, since the packing 24, 31 and 32 are fixed to the convex adhesive surface 23a of the housing 11 and come in contact with the internal surface of the plane cover body 15, even if the housing 11 and the cover body 15 are shifted in the horizontal direction, a contact state between the packing 24, 31 and 32 and the internal surface of the cover body 15 can be secured well so that a sealability can be improved.

### Second Embodiment

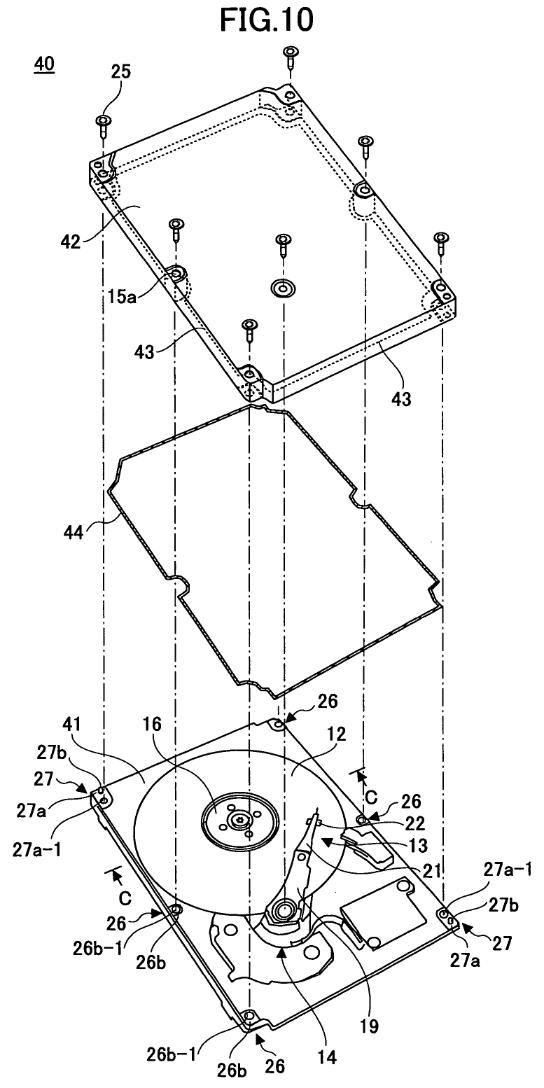

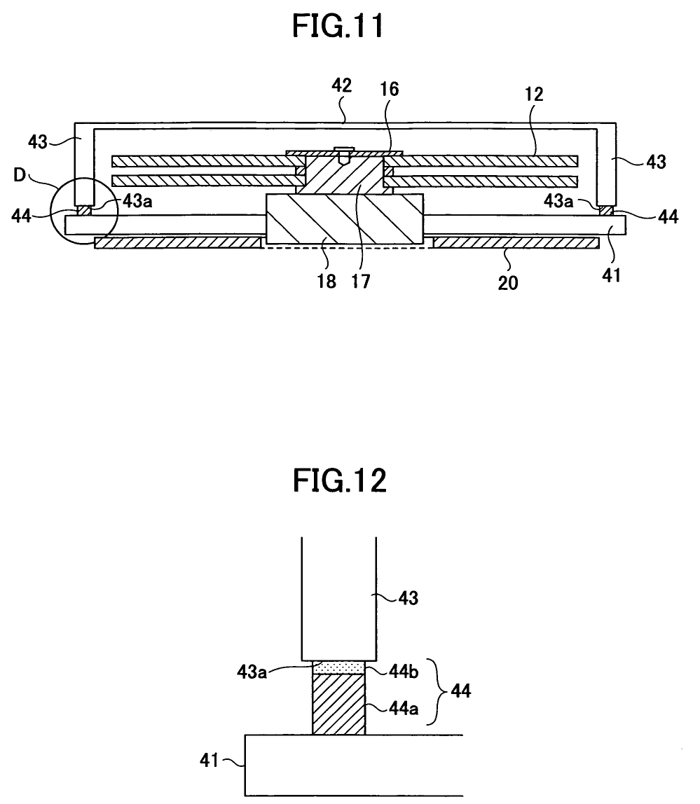

FIG. 10 is an exploded perspective view of a magnetic disk apparatus of a second embodiment of the present invention. FIG. 11 is a cross-sectional view taken along a line C-C of FIG. 10. FIG. 12 is an enlarged view of a part D of FIG. 11. In FIG. 10 through FIG. 12, parts that are the same as the parts discussed above are given the same reference numerals, and explanation thereof is omitted.

Referring to FIG. 10 through FIG. 12, in a magnetic disk apparatus 40 of the second embodiment, a housing 41 has a plate-shaped configuration and a circumference edge part 43 of the cover body 42 has a convex shape. Other than that the packing 44 is fixed to the adhesive surface 43a of the circumference edge part 43, the magnetic disk apparatus 40 has the same structure as the structure of the magnetic disk apparatus of the first embodiment.

The housing 41 has a plate-shape configuration. The magnetic disk 12, the magnetic head 13, and the actuator unit 14 are provided on a surface of the housing 41. A convex circumference edge part 43 is provided at the external circumference of the cover body 10. The packing 44 is fixed to the adhesive surface 43a which is a surface facing the housing 41 of the circumference edge part 43. It is not necessary for the entire housing part 41 to have a plate-shaped configuration. But a surface in the circumference edge part of the housing 41 where the packing 44 comes in contact with must be plane.

The packing 44 has the same structure as the packing shown in FIG. 7, FIG. 8A or FIG. 9. According to this embodiment, since the packing 44 is fixed to the convex adhesive surface 43a provided in the circumference edge part 43 of the cover body 42, even if the housing 41 and the cover body 42 are shifted in the horizontal direction, the surface of the packing 44 comes in contact with the plane surface of the housing 41 and therefore it is possible to form a good sealing state. The cover body 42 where the packing 44 is fixed in advance is positioned, provided and screw-fixed to the housing 41. Since the packing 44 is not exposed to the outside just before the cover body 42 is fixed in this process, a clean packing surface can be made to contact the internal surface of the cover body 41. Because of this, since it is possible to prevent the dust from existing between the packing 44 and the surface of the housing 41, a good sealing state can be formed.

According to this embodiment, since the packing 44 is fixed to the convex adhesive surface 43a of the cover body 42 and comes in contact with the plane and wide surface of the housing 41, even if the housing 41 and the cover body 42 are shifted in the horizontal direction, a contact state between the packing 44 and the surface of the housing 41 can be secured well so that sealability can be improved.

The present invention is not limited to these embodiments, but variations and modifications may be made without departing from the scope of the present invention.

This patent application is based on Japanese priority patent application No. 2005-187781 filed on Jun. 28, 2005, the entire contents of which are hereby incorporated by reference.

What is claimed is:

1. A magnetic disk apparatus, comprising:
a base body of which one surface is opened;
a cover part covering the opened surface of the base body; and
a recording and reproducing part provided on the base body and having a magnetic disk and a magnetic head received in a space formed between the base body and the cover part;
wherein a convex part is provided along a perimeter of a circumference edge part of one of the base body and the cover part;
a first surface of the convex part faces a second flat surface; and
a packing for sealing is fixed to the first surface of the convex part so as to come in contact with the second flat surface.

2. The magnetic disk apparatus as claimed in claim 1,
wherein a width of the second flat surface is larger than a width of the first surface.

3. The magnetic disk apparatus as claimed in claim 1,
wherein the convex part is provided along the perimeter of the circumference edge part of the base body;
a top surface of the convex part is the first surface; and
the second flat surface is provided on an internal surface of the circumference edge part of the cover body.

4. The magnetic disk apparatus as claimed in claim 1,
wherein the base body has a substantially plate-shaped configuration and the second flat surface is provided along the perimeter of the circumference edge part of the base body;
the convex part is provided along the perimeter of the cover part; and
a top surface of the convex part is the first surface.

5. The magnetic disk apparatus as claimed in claim 1,
wherein the packing is formed so that a width of the packing is smaller than a width of the first surface.

6. The magnetic disk apparatus as claimed in claim 1,
wherein a width of the packing is varied depending on a width of the first surface of the convex part.

7. The magnetic disk apparatus as claimed in claim 1,
wherein the packing is made of an elastic member and an adhesive member; and
the elastic member is made of a rubber material or an elastomer.

8. The magnetic disk apparatus as claimed in claim 1,
wherein a groove forming part is provided along a longitudinal direction in the center of a width direction of a surface of the packing in a state where the packing is not pressed.

9. The magnetic disk apparatus as claimed in claim 1,
wherein the packing is made of a liquid packing.
